(19) United States
(12) Patent Application Publication
(10) Pub. No.: US 2026/0218542 A1
(43) Pub. Date: Jul. 30, 2026

(54) AN ELECTROMAGNETIC LOCK HAVING AN ANTI-FORCED ENTRY MECHANISM

(71) Applicant: WENZHOU JINFU LOCKS INDUSTRY CO., LTD, Wenzhou, Zhejiang (CN)

(72) Inventor: Juxiang XU, Wenzhou, Zhejiang (CN)

(21) Appl. No.: 19/147,347

(22) PCT Filed: Jan. 16, 2023
(86) PCT No.: PCT/GB2023/050069

§ 371 Date: Jul. 11, 2025

(51) Int. Cl. E05B 17/20; E05B 15/04; E05B 27/00; E05B 47/06

(52) U.S. Cl. CPC E05B 17/2092; E05B 27/0014; E05B 47/0611; E05B 2015/0413; E05B 2015/0496

(57) ABSTRACT

An electromagnetic lock has an anti-forced entry mechanism which includes an electromagnetic lock arranged to releasably lock two members together. The electromagnetic lock is connected to anti-forced entry mechanism which includes a serial connection of an inner lock body, a locking cam and an outer lock body, an end of the outer lock body remote from the locking cam being provided with a manually operable lock such that the locking cam is arranged to be rotated between an unlocked and a locked position. The inner lock body includes an inner lock housing and axially slidably mounted on a longitudinally extending axis of the lock is an inner lock shaft which is biased by a compression spring. The inner lock shaft has a plurality of holes therein which are arranged to cooperate with a respective pin, each pin biased by a respective spring that is radially mounted in the inner lock housing. When the connection between the inner locking cam and the outer body is broken and the outer lock is broken away, the inner lock shaft is no longer restrained by the outer lock body and moves longitudinally axially under the bias of the spring so that the pins, under the force of their respective spring, are brought into alignment with the holes to thereby lock the inner shaft from rotating.

### CROSS-REFERENCE TO RELATED APPLICATIONS

The present application is a national stage entry from International Application No. PCT/GB2023/050069, filed on Jan. 16, 2023, published as International Publication No. WO 2024/153894 A1 on Jul. 25, 2024, the disclosure of which is hereby incorporated by reference in its entirety.

### FIELD

This invention relates to an electromagnetic lock having an anti-forced entry mechanism.

### BACKGROUND

Electromechanical locks are now well known to releasably lock members together. The lock may be connected to an anti-forced entry mechanism which includes the serial connection of an inner lock body, a locking cam and an outer lock body; an end of the outer lock body remote from the locking cam may be provided with a manually operable lock, often operated by a key to move tumblers so that rotation of the key in the lock rotates the locking cam between a locked and an unlocked position, whereby the two members may be locked or unlocked.

Typically, such an electromagnetic lock is mounted in a hole through a door and, extending orthogonally to a longitudinal axis of the hole, is a mortice through which a retractable locking bar is selectably movable into an aperture in a door frame. It is customary for the electromagnetic portion of the lock to be on the inside of the door with the key-operated portion on the exterior side of the door. It has been found that an intruder is readily able to twist and break off the outer lock body and then insert a screwdriver or the like into the cam to rotate the cam from a locked position to an unlocked position.

This invention seeks to provide an electromagnetic lock having an anti-forced entry mechanism where such a means of entry is made more difficult, if not impossible.

### SUMMARY

According to this invention there is provided an electromagnetic lock having an anti-forced entry mechanism including an electromagnetic lock arranged to releasably lock two members together, said electromagnetic lock being connected to said anti-forced entry mechanism, said anti-forced entry mechanism including on a longitudinal axis thereof a serial connection of an inner lock body, a locking cam and an outer lock body, an end of the outer lock body remote from the locking cam being provided with a manually operable lock such that the locking cam is arranged to be rotated between an unlocked and locked position, characterized in that the inner lock body includes an inner lock housing and axially slidably mounted on said longitudinal axis is an inner lock shaft in said inner lock housing which is biased by spring means, said inner lock shaft having a plurality of holes therein which are arranged to cooperate with a respective pin, each pin biased by a respective spring radially mounted in said inner lock housing, such that when the connection between the locking cam and the outer body is broken and the outer lock body is broken away, the inner lock shaft is no longer restrained by the outer body and longitudinal axially moves under the bias of the spring means so that the pins are brought into alignment with the holes under the force of their respective spring to thereby lock the inner lock shaft from rotating.

In a currently preferred arrangement, the spring means is biased in a direction away from said electromagnetic lock towards said cam and outer lock body.

Conveniently, the spring means is a compression spring.

Advantageously, the outer lock body is provided with a key lock mechanism at an end thereof remote from the electromagnetic lock.

Preferably, six equi-circumferentially spaced holes are situated in the inner lock shaft and a like plurality of pins are provided in the inner lock housing.

Advantageously, the pins, at an end remote from the spring associated therewith are each shaped as a truncated cone to assist in insertion into an associated hole.

Preferably, the locking cam has a spring biased retractable locking member, movable in a radial direction with respect to said longitudinal axis, and the inner lock body has an inner lock core with a longitudinal slot in the direction of the longitudinal axis, whereby the retractable locking member is arranged, upon rotation of the locking cam, to be biased into said slot to thereby lock the cam and the inner lock core from rotation, said longitudinal slot permitting translational movement of the inner lock shaft.

If the outer lock body is damaged and/or broken due to the application of force, the inner lock shaft is biased away from the electromagnetic lock towards the cam and the pins are axially moved to align with and move into the holes in the inner lock shaft to lock the position of the inner lock core so that the inner lock shaft cannot be rotated. In this manner, the anti-tamper performance of an electromagnetic lock is improved to thereby improve the security performance of the lock.

### BRIEF DESCRIPTION OF THE DRAWINGS

The invention will now be described, by way of example, with reference to the accompanying drawings, in which:

FIG. 1 shows a perspective view of an electromagnetic lock in accordance with this invention,

FIG. 2 shows a longitudinal cross-section of the lock shown in FIG. 1,

FIG. 3 is an enlarged view of portion a in FIG. 2,

FIG. 4 shows an enlarged view of portion b shown in FIG. 2,

FIG. 5 shows an exploded partial view of the anti-forced entry mechanism,

FIG. 6 shows a perspective view of the structure of a cylinder cam of the anti-forced entry mechanism, and

FIG. 7 shows a perspective view of an inner lock housing used in the mechanism of this invention.

In the drawings like reference numerals denote like parts.

### DETAILED DESCRIPTION

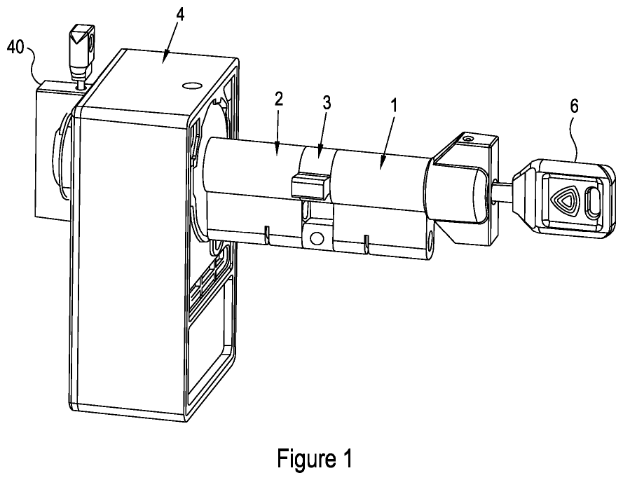

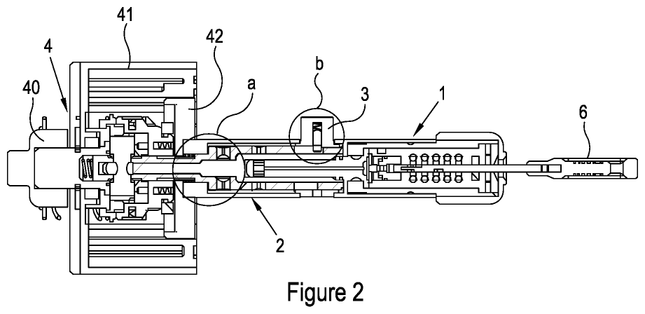

The electromagnetic lock shown in FIG. 1 has the serial connection of an outer lock body 1, a locking cam 3, and an inner lock body 2 and an internal shaft of the inner lock body extends into, and cooperates with, an electromagnetic lock inside a housing 4. The housing 4 for electronic components that may be able to operate in a smart manner with a cell phone to provide a lock, has a handle 40 (shown in FIG. 2), usually located on an inside of a door or window (not shown). At a remote end of the outer lock body remote from the housing 4 is a manually operable key 6 which cooperates with a tumbler mechanism inside the outer lock body and rotation of the key is arranged to rotate the locking cam 3 from a locked position to an unlocked position with respect to the inner lock body 2.

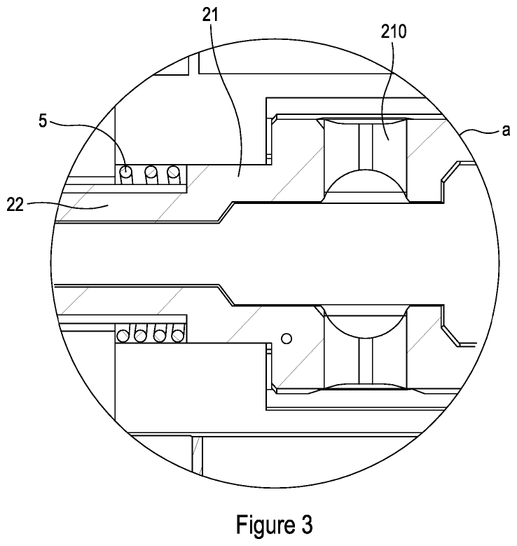

Referring to FIGS. 2, 3 and 5, the inner lock body 2 has an inner lock housing 20 which accommodates an inner lock shaft 21 which extends longitudinally along a longitudinal axis through the serial connection of the inner lock body 2, locking cam 3 and outer lock body 1, and the inner lock shaft 21 extends into the cam 3. Remote from the cam 3 on the inner lock shaft 21 is an extension shaft 22 having, with respect to the longitudinal axis, a transverse cross-section which is smaller than the cross-section of the inner lock shaft 21, the extension shaft 22 linking with an electromechanical linkage 41 inside the housing 4 and the rotatable handle 40. Rotation of the handle 40 is arranged to rotate the extension shaft 22 and the inner lock shaft 21. The extension shaft 22 extends through an end wall 42 of the housing 4 and a compression spring 5 is provided around the circumference of the extension shaft 22 and one end of the spring abuts an end wall 42 of the housing to resist movement of the spring in the left hand direction (as viewed in the Figures) and the other end of the compression spring 5 urges the inner lock shaft to the right (as shown in the Figures).

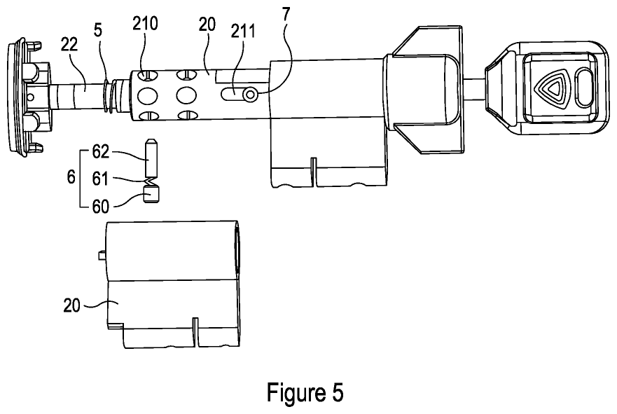

As shown in FIG. 5, the inner lock shaft has two rows of circumferentially equi-spaced holes 210 and in a preferred embodiment, six circumferentially equi-spaced holes are provided.

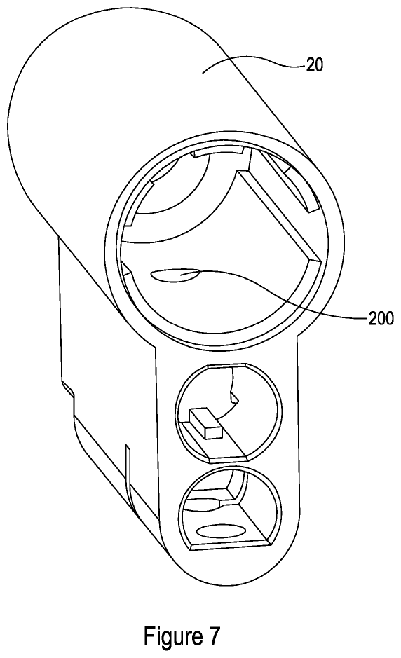

Referring to FIG. 7, the inner lock housing 20 has radially (with respect to the longitudinal axis) holes 200 having a closed inner end and in the closed inner end is a locking element 6 formed by a base 60 abutting the closed end of the holes 200, a compression spring 61 and a pin 62 having a truncated cone end remote from the compression spring 61 so as to assist insertion into a respective one of the holes 210. Thus, preferably there are a like number of pins 62 as there are holes 210 in a row.

The inner lock shaft 21 also has a longitudinally extending slot 211.

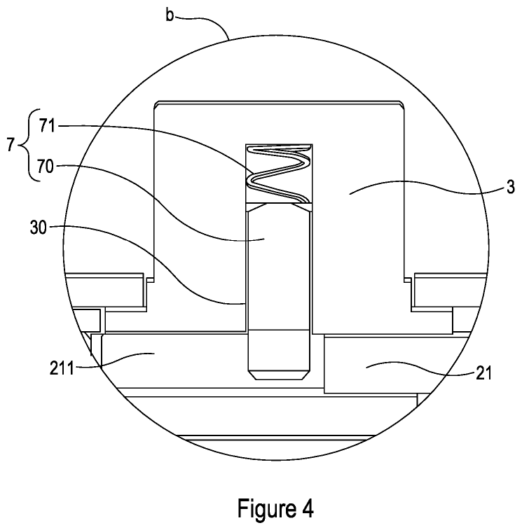

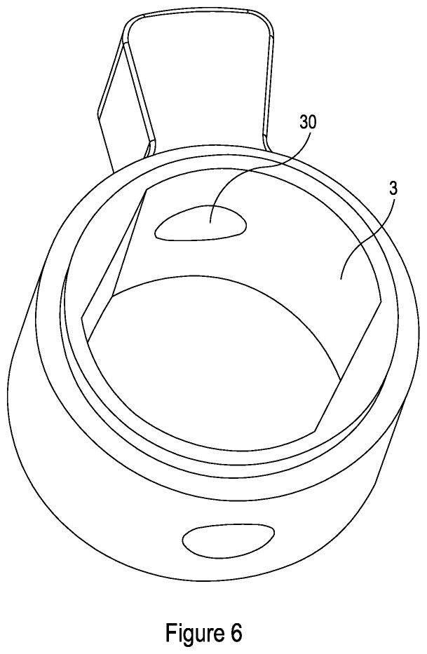

Referring to FIG. 4, the cam 3 has a radially extending bore 30 in which is located a retractable locking member 7 comprising a compression spring 71 and a locking pin 70, the compression spring 71 urging the locking pin 70 into the slot 211 of the inner lock shaft 21. The bore 30 of the cam 3 is also shown in FIG. 6. Thus, the locking pin 70 is arranged to move along an inner cam surface of the cam 3 when the cam is rotated so that when the cam is rotated, the locking pin 70 may be biased into the slot 211 to secure the inner lock shaft 21.

In operation, when the lock is vandalized by breaking the joint between the cam 3 and the outer lock 1, the outer lock body 1 breaks away from the entire lock. When this happens, the inner lock shaft 21 of the inner lock body 2 no longer experiences resistance from the outer lock body 1, resulting in the inner lock shaft 21 being urged by the compression spring 5 to move in a direction formerly occupied by the outer lock body 1, that is, to the right as views in the Figures.

When the inner lock shaft 21 moves, the position of the limiting holes 21 move into alignment with the locking element 6 so that the pins 62 are urged by compression spring 61 into a respective limit hole 210. The slot 211 facilitates movement of the inner lock shaft 21 within the cam 3 so that the inner shaft 21 is able to move with respect to the cam 3 and its associated locking pin 70.

When the pins 62 are inserted into the hole 210 the inner lock shaft 21 is in a locked state and cannot be rotated, even using an external locking tool, and the inner lock shaft 21 cannot be unlocked.

There has, thus, been described an anti-forced entry mechanism of an electromagnetic lock which greatly improves the security performance of the lock.

It will be understood that the description above is in relation to a preferred embodiment of the invention and the scope of protection is not limited to the embodiment described but is limited by the claims appended hereto

1. An electromagnetic lock having an anti-forced entry mechanism including an electromagnetic lock arranged to releasably lock two members together, said electromagnetic lock being connected to said anti-forced entry mechanism, said anti-forced entry mechanism including on a longitudinal axis thereof a serial connection of an inner lock body, a locking cam and an outer lock body, an end of the outer lock body remote from the locking cam being provided with a manually operable lock such that the locking cam is arranged to be rotated between an unlocked and locked position, characterized in that the inner lock body includes an inner lock housing and axially slidably mounted on said longitudinal axis in said inner lock housing is an inner lock shaft which is biased by spring means, said inner lock shaft having a plurality of holes therein which are arranged to cooperate with a respective pin, each pin biased by a respective spring radially mounted in said inner lock housing, such that when the connection between the locking cam and the outer body is broken and the outer lock body is broken away, the inner lock shaft is no longer restrained by the outer body and longitudinal axially moves under the bias of the spring means so that the pins are brought into alignment with the holes under the force of their respective spring to thereby lock the inner lock shaft from rotating.

2. A lock as claimed in claim 1, wherein the spring means is biased in a direction away from said electromagnetic lock towards said cam and outer lock body.

3. A lock as claimed in claim 1, wherein the spring means is a compression spring.

4. A lock as claimed in claim 2, wherein the outer lock body is provided with a key lock mechanism at an end thereof remote from the electromagnetic lock.

5. A lock as claimed in claim 1, wherein six equi-circumferentially spaced holes are situated in the inner lock shaft and a like plurality of pins are provided in the inner lock housing.

6. A lock as claimed in claim 1, wherein the pins, at an end remote from the spring associated therewith are each shaped as a truncated cone to assist in insertion into an associated hole.

7. A lock as claimed in claim 1, wherein the locking cam has a spring biased retractable locking member, movable in a radial direction with respect to said longitudinal axis, and the inner lock body (2) has an inner lock core (21) with a longitudinal slot (211) in the direction of the longitudinal axis, whereby the retractable locking member is arranged, upon rotation of the locking cam, to be biased into said slot to thereby lock the cam and the inner lock core from rotation, said longitudinal slot permitting translational movement of the inner lock shaft.

8. A lock as claimed in claim 2, wherein the spring means is a compression spring.

9. A lock as claimed in claim 1, wherein the outer lock body is provided with a key lock mechanism at an end thereof remote from the electromagnetic lock.

10. A lock as claimed in claim 2, wherein the outer lock body is provided with a key lock mechanism at an end thereof remote from the electromagnetic lock.

11. A lock as claimed in claim 3, wherein the outer lock body is provided with a key lock mechanism at an end thereof remote from the electromagnetic lock.

12. A lock as claimed in claim 8, wherein the outer lock body is provided with a key lock mechanism at an end thereof remote from the electromagnetic lock.

13. A lock as claimed in claim 2, wherein six equi-circumferentially spaced holes are situated in the inner lock shaft and a like plurality of pins are provided in the inner lock housing.

14. A lock as claimed in claim 3, wherein six equi-circumferentially spaced holes are situated in the inner lock shaft and a like plurality of pins are provided in the inner lock housing.

15. A lock as claimed in claim 8, wherein six equi-circumferentially spaced holes are situated in the inner lock shaft and a like plurality of pins are provided in the inner lock housing.

16. A lock as claimed in claim 4, wherein six equi-circumferentially spaced holes are situated in the inner lock shaft and a like plurality of pins are provided in the inner lock housing.

17. A lock as claimed in claim 9, wherein six equi-circumferentially spaced holes are situated in the inner lock shaft and a like plurality of pins are provided in the inner lock housing.

18. A lock as claimed in claim 10, wherein six equi-circumferentially spaced holes are situated in the inner lock shaft and a like plurality of pins are provided in the inner lock housing.

19. A lock as claimed in claim 11, wherein six equi-circumferentially spaced holes are situated in the inner lock shaft and a like plurality of pins are provided in the inner lock housing.

20. A lock as claimed in claim 1, wherein the locking cam has a spring biased retractable locking member movable in a radial direction with respect to said longitudinal axis, and the inner lock body has an inner lock core with a longitudinal slot in the direction of the longitudinal axis, whereby the retractable locking member is arranged, upon rotation of the locking cam, to be biased into said slot to thereby lock the cam and the inner lock core from rotation, said longitudinal slot permitting translational movement of the inner lock shaft.
